(19) United States
(12) Patent Application Publication
(10) Pub. No.: US 2014/0034629 A1
(43) Pub. Date: Feb. 6, 2014

(54) UNITIZED INTERMEDIATE BULK CONTAINER BASEPAD

(71) Applicants: Clifford Hedquist, Lisle, IL (US); Todd Hayward, Lisle, IL (US)

(72) Inventors: Clifford Hedquist, Lisle, IL (US); Todd Hayward, Lisle, IL (US)

(21) Appl. No.: 13/568,067

(22) Filed: Aug. 6, 2012

(51) Int. Cl. H05B 3/02

(52) U.S. Cl. 219/385

(57) ABSTRACT

A reusable and thermally efficient pad for heating the contents of intermediate bulk shipping containers is formed combined in a unitized manner, with a means for securing the heating pad cord, portions for handles, tie-off connection points. and a portion for a spout of the shipping bladder container to protrude through for pouring. The heating pad panel is reusable, and the pad is used with a combination of thermally efficient material layers for trapping and deflecting heat energy into the product.

### CROSS-REFERENCES TO RELATED APPLICATIONS

(Not Applicable)

### STATEMENT REGARDING FEDERALLY-SPONSORED RESEARCH AND DEVELOPMENT

(Not Applicable)

### REFERENCE TO AN APPENDIX

(Not Applicable)

### BACKGROUND OF THE INVENTION

1. Field of the Invention

This invention relates generally to shipping container base pads, and more specifically to base pads used for heating materials in a shipping container bladder.

2. Description of the Related Art

Products such as oil, milk fats, and butter liquor are shipped as solids or semi-solids in large intermediate bulk shipping bladders, each of which rests on a heating pad. Upon reaching the destination, the bladders are heated by activating each heating pad, thereby heating the bladders, and the materials therein become viscous enough for pouring.

The prior art heating pads utilize a heating blanket wrap. This is a heating mat combined with a cloth layer to wrap around a bladder for heating the contents therein. The heat loss through the floor is of a great magnitude, making this process inefficient and costly.

In another manner, typically seen in the industry, the heating element is a flat mat or pad, with a coil of heating element contained in an insulating material. Underneath the heating pad is a piece of cardboard. This is a disposable layer between the heating pad and the floor. An electric cord for the heating pad protrudes through a hole in the cardboard. After the heating process is completed, the cardboard is tugged and the cord tears the cardboard, which then becomes waste.

The issue with the prior art methods and materials is that heat loss from the heating pad into the floor is of a large magnitude. This is difficult to overcome because the industrial floor is typically is concrete or metal. Another major issue with the prior art is that the large amount of waste is costly. The cardboard is not reusable, thereby resulting is increased costs through production needs and waste disposal. The backboard must be produced and then used only once.

The present invention overcomes the problems in the prior art. The present invention is reusable and reduces up to half of the heat loss.

### BRIEF SUMMARY OF THE INVENTION

A unitized heating pad for heating the contents of intermediate bulk shipping containers is reusable and thermally efficient. The pad has a heating mat attached to a panel. The panel has portions designed for accepting the heating pad cord in friction locking manner, handles, tie-off connection points, and a portion for a spout of the shipping bladder container to protrude through for pouring out the heated contents at a destination. The heating pad panel is reusable, and the pad is used with a combination of thermally efficient material layers for trapping and deflecting heat energy into the product.

### BRIEF DESCRIPTION OF THE SEVERAL VIEWS OF THE DRAWINGS

FIG. 1 is face view showing the preferred embodiment for the invention.

FIG. 2 is a side view of the preferred embodiment showing the panel showing the cord holes and cord tie points, the handle, the bunghole opening.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

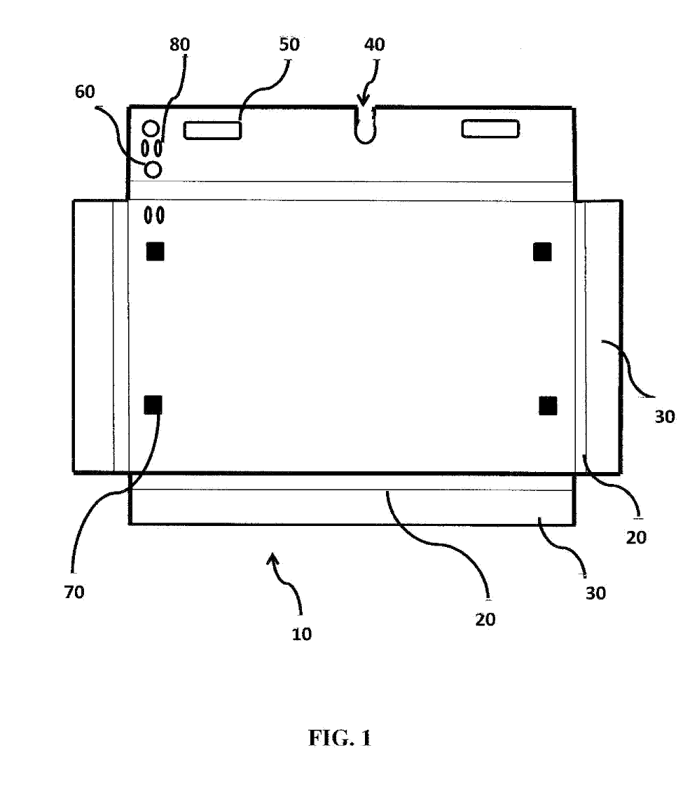

FIG. 1 shows the preferred embodiment for a panel 10 used in an inventive unitized heating pad. The panel 10 has at least one pair of cord holes 60. A cord of a standard electrical heating mat is threaded and held in friction locking fashion (not shown). Tie points 80 serve to allow additional means to be utilized for securing the cord, such as a plastic tie or wire. The cord must be secured onto on the panel 10 in order to have the container rest evenly on a floor, held in a predetermined position by the friction-holding cord holes 60.

The panel 10 has a plurality of heating pad fasteners 70. The heating pad is removably secure to the panel 10 by way of the fasteners 70, which can be standard interlocking fabric means, or a flexible hook and paw, or snaps. The heating pad (not shown) would stay fastened onto the panel 10 because the panel is reusable. It is conceivable that the panel 10, however, may have a heating pad rigidly and semi-permanently attached to the panel 10, for example, by a rivet or bolt.

The pane 10 has at least two handles 50. In, this way, a user easily grasps the panel 10 and removes the heating pad. The panel 10 also has cauterized longitudinal edges 20 which impart flexibility, in order to form folding lateral side flaps 30.

The inventive panel 10 may include a polyshield layer of thermally reflective material layered on the bottom face of the panel 10, opposite to the face that has the heating pad fasteners 70. This polyshield layer, preferably reflective mylar, reflects the heat from the floor side of the panel, back upwardly into the bladder.

The combination heating pad also may include an absorption support layer, preferably a dense polystyrene layer. The layer absorption support layer provides additional support of the bladder and maintains the container off the floor. The layer also absorbs heat, thereby forming a heated barrier that serves as a heat reservoir. In this way, heat loss is also minimized by slowing the normal heat flow along a concentration gradient, flowing from the heat source at the combination heating mat and panel.

The inventive panel has a portion forming an aperture to serve as a bunghole inlet 40. The intermediate bulk shipping container arrives at a destination, and the contents in a bladder therein are warmed by the activation of the heating mat, typically to about 160 degrees Fahrenheit. The content, once viscous, is poured from the bladder through a spout or other means. The materials in the pad, specifically the polystryrene layer, return to the pre-compressed state. In the preferred embodiment, the panel has an opening portion for access to a bunghole on a standard bladder used in the bulk shipping container. The bunghole inlet 40 aperture seen in FIG. 1 is another inventive feature of the invention allowing for reusability and waste reduction.

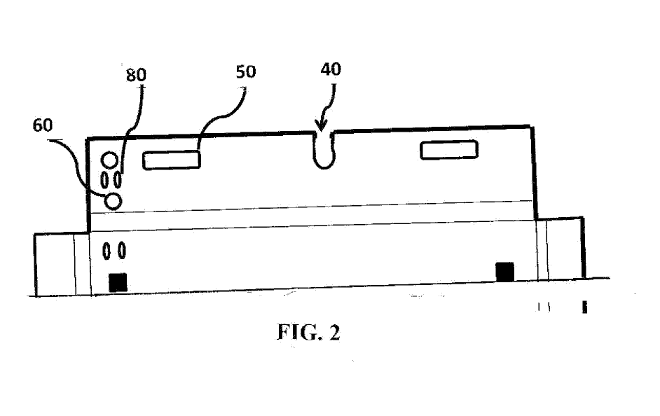

The panel material is preferably a corrugated plastic of other similarly resistant material having flexing capability. As seen in FIG. 2, the preferred embodiment has longitudinal cauterization lines 20 that impart hinge functionality to create side flaps 30. The flaps 30 are beveled upwardly to form some lateral divisional and supportive aspect to the combination heating pad. The container rests in the pad and the side flaps 30 fold up against the container sides. This aspect also causes heat energy from the heating pad combination to be retained.

While certain preferred embodiments of the present invention have been disclosed in detail, it is to be understood that various modifications may be adopted without departing from the spirit of the invention or scope of the following claims.

1. A heating base pad for an intermediate bulk shipping container, comprising:
(A) a heating mat having an electrical heating element cord secured in a substantially planar configuration, with a plug end of said cord protruding from said mat;
(B) at least one longitudinal cauterized hinge extending the length of said pad, thereby forming a flap side panel hingedly connected to said panel, whereby said hinged side panel is beveled upwardly;
(C) a panel having a multiplicity of connection points for detachably connecting to said heating mat, wherein said panel has a plurality of portions forming apertures for accepting a section of said cord in friction locking manner for securing said cord in said panel.

2. A heating base pad for an intermediate bulk shipping container, comprising:
(A) a heating mat having an electrical heating element cord secured in a substantially planar configuration, with a plug end of said cord protruding from said mat;
(B) a panel having a multiplicity of connection points for detachably connecting to said heating mat, said panel having a plurality of portions forming apertures for accepting a section of said cord in friction locking manner for securing said cord in said panel;
(C) a thermal pad layer, said layer having an upper sectional thermally-reflective barrier and a thermally absorptive barrier.

3. The base pad of claim 2, wherein said thermally-reflective layer is made of mylar, and said thermally-absorptive layer is made of polystyrene.
